(19) United States
(12) Patent Application Publication
(10) Pub. No.: US 2018/0076751 A1
(43) Pub. Date: Mar. 15, 2018

(54) CONTROL APPARATUS AND CONTROL METHOD

(71) Applicant: KABUSHIKI KAISHA TOSHIBA, Tokyo (JP)

(72) Inventors: Shigen YASUNAKA, Tokyo (JP); Shinji TAKAKURA, Yokohama (JP)

(73) Assignee: KABUSHIKI KAISHA TOSHIBA, Tokyo (JP)

(21) Appl. No.: 15/445,005

(22) Filed: Feb. 28, 2017

(30) Foreign Application Priority Data
Sep. 13, 2016 (JP) P2016-178680

(51) Int. Cl. H02P 23/14; H02P 27/08; H02P 6/14

(52) U.S. Cl. CPC H02P 23/14; H02P 6/14; H02P 27/08

(57) ABSTRACT

According to one embodiment, a control apparatus identifies a load characteristic of a circuit by an impulse response. In the control apparatus, a controller provides a control signal. A first generator generates first gate signals based on the control signal. A second generator generates second gate signals to identify the load characteristic of the circuit. A switching part switches connection to one of the first generator and the second generator. A bridge circuit connected to the switching part includes a plurality of switching elements. When the switching part is connected to the first generator, the switching elements are operated based on the first gate signals, and the bridge circuit outputs a first signal. When the switching part is connected to the second generator, the switching elements are operated based on the second gate signals, and the bridge circuit outputs an impulse second signal different from the first signal.

### CROSS-REFERENCE RELATED APPLICATIONS

This application is based upon and claims the benefit of priority from Japanese Patent Application No. 2016-178680, filed on Sep. 13, 2016; the entire contents of which are incorporated herein by reference.

### FIELD

Embodiments of the present invention relate to a control apparatus and a control method.

### BACKGROUND

In a ease of a current control system which uses high voltages and high currents such as drive control of a rotating electric machine, an inverter circuit (main circuit) is formed by using switching elements such as insulated gate bipolar transistor (IGBT) and a voltage is applied to a load (for example, a coil of the rotating electric machine) by pulse width modulation (PWM) control. Then, a command value corresponding to the current error between a current command value and a measured current value flowing to the load is computed by a controller to control the current. Since resistance values and inductances are varied depending on individual differences and temperatures, in order to carry out high-precision control, there is a demand to identify characteristics from the terminal voltage to a current of the load by online in a short, period of time.

For example, in a method of flowing a constant current in order to identify a resistance value, consumed electric power is large, and the resistance value may be varied due to the current. Moreover, the characteristic of inductance cannot be measured at the same time. In a method of carrying out frequency oscillation, identification takes a lot of time and consumed electric power.

Therefore, it is conceivable to measure an impulse response and carry out identification as a FIR model. However, in a configuration in which the Duty rate of PWM output is determined by comparison of a control command and a triangular wave, when an impulse input is applied to a control command value, a voltage 0 is not output due to the influence of Dead time. Therefore, a precise characteristic cannot be identified.

### BRIEF DESCRIPTION OF DRAWINGS

FIG. 1 shows a block diagram of a current control system of a control apparatus 1 according to a first embodiment.

FIG. 2 shows a circuit diagram in which a load 8 is connected to an inverter having a bridge circuit 6, which includes four switching elements, and a LPF 7.

FIG. 3 shows gate signals generated from a control command signal (cmd) and a carrier signal (cs).

FIG. 4 shows an example of the gate signals of a generator 4b for identifying a load characteristic.

FIG. 5 shows transitions of the bridge circuit in a case in which the switching elements are operated based on the gate signals shown in FIG. 4.

FIG. 6 shows an example of an operation flow of the control apparatus 1 according to the first embodiment.

FIG. 7 shows a block diagram of a case in which a load characteristic of Comparative Example 10 is to be identified.

FIG. 8 shows gate signals generated by a generator 40 in a case in which the control command signal (cmd) is 0.

FIGS. 9A and 9B show the state of the bridge circuit during Dead time.

FIGS. 10A and 10B show impulse responses of currents and terminal voltages in a case in which a second mode of a controller 1 according to the first embodiment is applied and a case of Comparative Example.

FIGS. 11A and 11B show frequency characteristics of loads of the first embodiment and Comparative Example with respect to a target model.

FIG. 12 shows gate signals created by the generator 4b of the control apparatus 1 according to a second embodiment.

FIG. 13 shows gate signals created by the generator 4b of the control apparatus 1 according to a third embodiment.

FIG. 14 shows gate signals created by the generator 4b of the control apparatus 1 according to a fourth embodiment.

FIG. 15 shows operation patterns of switching elements 6a to 6d according to the gate signals of the generator 4b according to the first to fourth embodiments.

### DETAILED DESCRIPTION

According to one embodiment, a control apparatus can identify a load characteristic of a circuit by an impulse response. The control apparatus includes a controller, a first generator, a second generator, a switching part, and a bridge circuit. The controller provides a control signal. The first generator generates first gate signals based on the control signal. The second generator generates second gate signals to identify the load characteristic of the circuit. The switching part switches connection to one of the first generator and the second generator. The bridge circuit, connected to the switching part includes a plurality of switching elements. In case that the switching part, is connected to the first generator, the switching elements are operated based on the first gate signals, and the bridge circuit outputs a first signal. In case that the switching part is connected to the second generator, the switching elements are operated based on the second gate signals, and the bridge circuit outputs an impulse second signal different from the first signal.

Hereinafter, control apparatuses according to embodiments will be described with reference to drawings. Those denoted by the same reference signs represent similar things. Note that the drawings are schematic or conceptual, and the relations between the thicknesses and widths of parts, the proportional coefficients of the sizes between the parts, etc. are not always the same as the actual ones. Also, even in a case in which they represent the same parts, the mutual dissensions and proportional coefficients may be shown differently depending on the drawings in some cases.

### First Embodiment

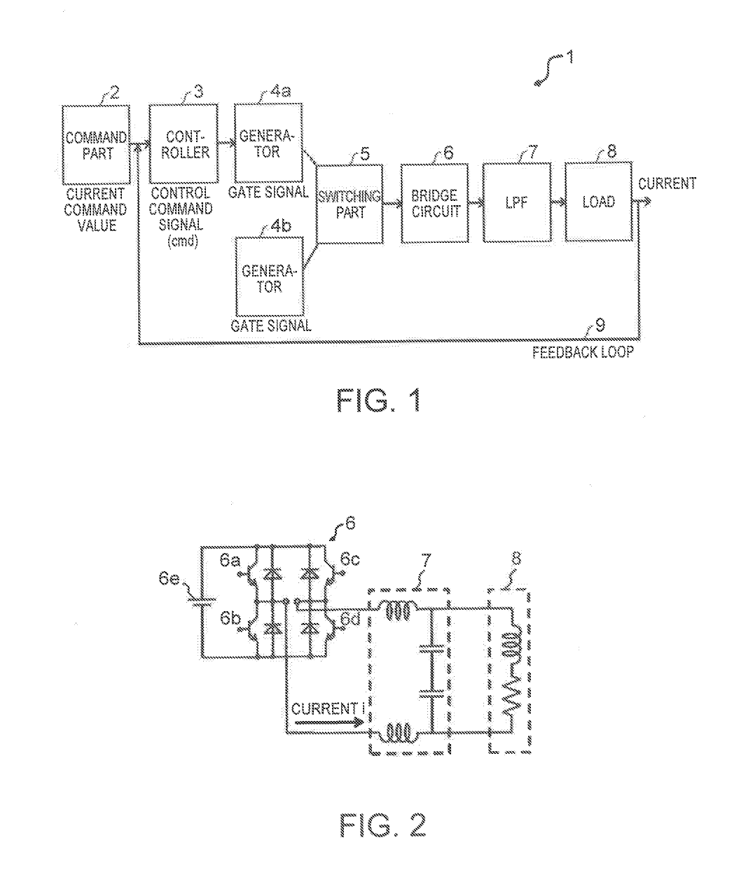

The control apparatus according to the first embodiment will be described with reference to FIG. 1 to FIG. 6, FIG. 1 shows a block diagram of a current control system of the control apparatus 1 according to the first embodiment.

The control apparatus 1 of the present embodiment applies impulse inputs to a load 8 by individually subjecting switching elements of a bridge circuit 6 to On/Off operations and identifies a load characteristic with high precision by the responses thereof.

The control apparatus 1 includes a command part 2, which provides a current command value serving as a target, a control part 3, which outputs a control command signal corresponding to a current error between the current command value and an actually flowing current, a generator 4a, which generates gate signals for controlling On/Off of switching elements based on carrier signals (carrier waves) and the control command signal, and a generator 4b, which generates gate signals for controlling On/Off of the switching elements and outputting impulse signals. Furthermore, the control apparatus includes a switching part 5, which carries out: switching of measurement modes by switching the connection of the generator 4a and the generator 4b, a bridge circuit 6, which has the plurality of switching elements and operates each of the switching elements based on the gate signals of either the generator 4a or the generator 4b, a low pass filter (LPF) 7, which subjects the high-frequency components output from the bridge circuit 6 to filtering, and a load 8 connected to the LPF 7.

The switching part 5 carries out switching of a so-called normal operation (referred to as a first mode) for the circuit of not identifying the characteristic of the load 8, and an operation (referred to as a second mode) of identifying the characteristic of the load 8.

First, the first mode, which is the normal operation in which the load characteristic of the circuit is not identified, will be described.

In the case of the first mode, the switching part 5 of the control apparatus 1 carries out switching so that the gate signals of the generator 4a are supplied to the bridge circuit 6. The switching part 5 may be a switch, a switching element, a semiconductor element, or the like.

The command part 2 is a part which computes encoder information, etc. and creates the command value. The command value is provided by a current. The command part 2 corresponds to a digital signal processor (DSP) or a central processing unit (CPU). The command value is not limited to a current value, but may be a voltage value or the like.

The controlled 3 obtains the difference between the actual current from a feedback loop 9 provided outside and the current command value, and amplifies it to convert it to the control command signal. The actual current from the feedback loop 9 is calculated by using the load characteristic identified by the second mode, which will be described later.

The controller 3 corresponds to a microprocessor, a micro control unit (MCU), or the like.

The generator 4a generates the gate signals for controlling On/Off of the switching elements based on the control command signal of the controller 3 and the carrier signal (carrier wave).

The bridge circuit 6 operates each of the switching elements based on the gate signal of the generator 4a, thereby outputting a pulse width modulation (PWM) signal. This PWM signal corresponds to a so-called voltage signal (also referred to as a first signal). The LPF 7 is connected to the bridge circuit and subjects the high-frequency components of the PWM signal to filtering. The LPF 7 is connected to the load 8.

The generator 4a compares the control command signal from the controller 3 with the carrier signal, thereby generating the gate signal for subjecting the switching element of the bridge circuit 6 to On/Off operation.

The bridge circuit 6 has four switching elements, and free wheeling diodes are connected in parallel, to the switching elements, respectively. In a case in which semiconductor devices such as insulated gate bipolar transistors (IGBT) are used as the switching elements, currents flow only in forward directions. Therefore, in the case in which the semiconductor devices are used as the switching elements, it is general to connect free wheeling diodes in parallel to the elements, respectively so that currents flow also in reverse directions. As the switching elements, other than IGBTs, Metal-Oxide Semiconductor Field Effect Transistors (MOSFET) may be also used. The MOSFET incorporates a free wheeling diode and is therefore provided with the characteristic of the free wheeling diode.

FIG. 2 shows a circuit diagram in which the load 8 is connected to an inverter having the bridge circuit 6, which includes four switching elements, and the LPF 7. As shown in FIG. 2, the first switching element 6a˜the fourth switching element 6d are connected to an electric power source 6e and the LPF 7. A direct-current electric power source is used as the electric power source 6e. The LPF 7 includes two capacitors (C) and two coils (L). Furthermore, the LPF 7 is connected to the load 8. The load 8 includes a coil (L) and a resistance R. The configuration of the LPF 7 is not limited to this, but may be formed by a circuit having a capacitor (C) and a resistance (R), or may be formed by a circuit having a coil (L), a capacitor (C), and a resistance (R). The load 8 may be formed only with a resistance (R) or a coil (L), or a capacitor (C) may be added thereto. Meanwhile, the lead 8 is, for example, an inductor for inductance. The control apparatus 1 is described as a configuration including the LPF 7. However, the LPF 7 is not an essential configuration, and the control apparatus includes a case without the LPF 7.

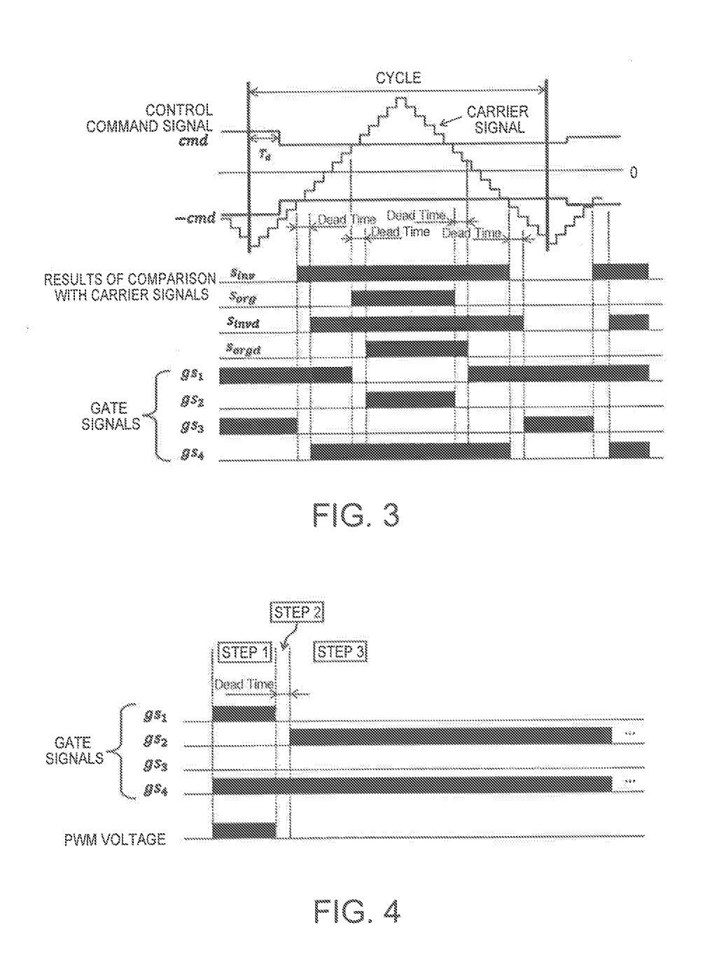

Next, the gate signals generated by the generator 4a will be described in detail by using FIG. 3. FIG. 3 shows the gate signals generated from the control command signal (cmd) and the carrier signal (cs).

As shown in FIG. 3, the carrier signal (cs) is expressed by a triangular wave or a sawtooth wave. The carrier signal (cs) is provided by, for example, an oscillator (not shown) provided outside. The generator 4a compares the carrier signal (cs) with the control command signal (cmd), outputs a signal of “1” if the carrier signal (cs) is high than the control command signal (cmd), and outputs a signal of “0” if the carrier signal (cs) is lower than the control command signal (cmd). The comparison between the carrier signal (cs) and the control command signal (cmd) is carried out by, for example, a comparator (not shown) in the generator 4a. In the generator 4a, four gate signals gs₁ to gs₄ for operating the first switching element 6a to the fourth switching element 6d of the bridge circuit 6 are generated. Herein, if the gate signal is “0”, the switching element becomes the state of Off, and, if the gate signal is “1”, the switching element becomes the state of On.

The relation between the carrier signal (cs) and the control command signal (cmd) can be expressed by following Equations (1) and (2).

$$\begin{matrix}{s}_{org} = \{ \begin{matrix}1 & cs \geq cmd \\ 0 & cs < cmd\end{matrix} & ( 1 ) \\ {s}_{inv} = \{ \begin{matrix}1 & cs \geq - cmd \\ 0 & cs < - cmd\end{matrix} & ( 2 )\end{matrix}$$

Meanwhile, if the switching elements disposed above and below in the bridge circuit 6 are turned on at the same time, the electric power source 6e is short-circuited. For example, if the first switching element 6a and the second switching element 6b become an On state at the same time or if the third switching element 6c and the fourth switching element 6d become an On state at the same time, the electric power source 6e becomes a short-circuited state. Particularly, since a semi conductor device is set to have an extremely small resistance value so that a voltage drop amount upon turning-On of the switching element becomes small, for example, if the first switching element 6a and the second switching element 6b become the On state at the same time, the electric power source becomes a short-circuited state. In order to avoid this, the time during which the first switching element 6a and the second switching element 6b or the third switching element 6c and the fourth switching element 6d are turned off at the same time is provided (referred to as Dead time).

The signals obtained by delaying the signals S_{org} and Sᵢₙᵥ expressed by Equations (1) and (2) by the amount of the Dead time are referred to as S_{orgd} and S_{invd}, respectively. By using the signals of S_{org}, Sᵢₙᵥ, and S_{invd}, the nals gs₁ to gs₄ can be expressed by following Equations (3) to (6).

gs₁=s̅_̅{̅o̅r̅g̅}̅+̅s̅_̅{̅o̅r̅g̅d̅}̅ (3)

gs₂=s_{org}·s_{orgd} (4)

gs₃=s̅ᵢ̅ₙ̅ᵥ̅+̅s̅_̅{̅i̅n̅v̅d̅}̅ (5)

gs₄=sᵢₙᵥ·s_{invd} (6)

When the switching elements are subjected to On/Off operations depending on the gate signals gs₁ to gs₄ generated in such a manner, the PWM signal is output.

The LPF 7 subjects the PWM signal to filtering, thereby removing the high-frequency components of the PWM signal and carrying out smoothing. For example, a voltage signal close to a sine wave is applied to the load 8.

As described above, the first mode represents the normal operation of the circuit of the control apparatus 1 of the first embodiment. The normal operation is, for example in a case of an inverter circuit, an operation of converting a direct current to an alternating current by PWM control. It is not limited to the inverter circuit, and normal operations of a converter circuit, a circuit of a current control system, etc. are also included.

Next, the second mode of the case in which the load characteristic of the circuit 8 is to be identified by the control apparatus 1 will be described.

In the second mode, the characteristic of the load 8 are identified in a short period of time by an impulse response. In the case of the second mode, the switching part 5 of the control apparatus 1 carries out switching so that the gate signals of the generator 4b are supplied to the bridge circuit 6. As a result, the command part 2, the controller 3, and the generator 4a are isolated from the bridge circuit 6, the LPF 7, and the load 8.

The bridge circuit 6 is connected to the generator 4b and operates the switching elements based on the gate signals generated by the generator 4b. The LPF 7 and the load 8 are connected to the bridge circuit 6.

The generator 4b generates the gate signals for directly operating the switching elements and applying the impulse input to the load 8.

FIG. 4 shows an example of the gate signals of the generator 4b for identifying the load characteristic.

As shown in FIG. 4, the gate signals respectively operate the switching elements from step 1 to step 3 along a time series.

When an impulse input of a positive direction is to be applied, the first switching element 6a and the fourth switching element 6d are turned on at the same time and are connected to the electric power source 6e (step 1). At that point, the second switching element 6b and the third switching element 6c are Off. Then, the first switching element is turned off, and Dead time for preventing short-circuit of the electric power source 6e is allowed to elapse (step 2). Then, the second switching element is turned on (step 3). Then, the switching elements are not subjected to operation until the current converges to “0” (zero).

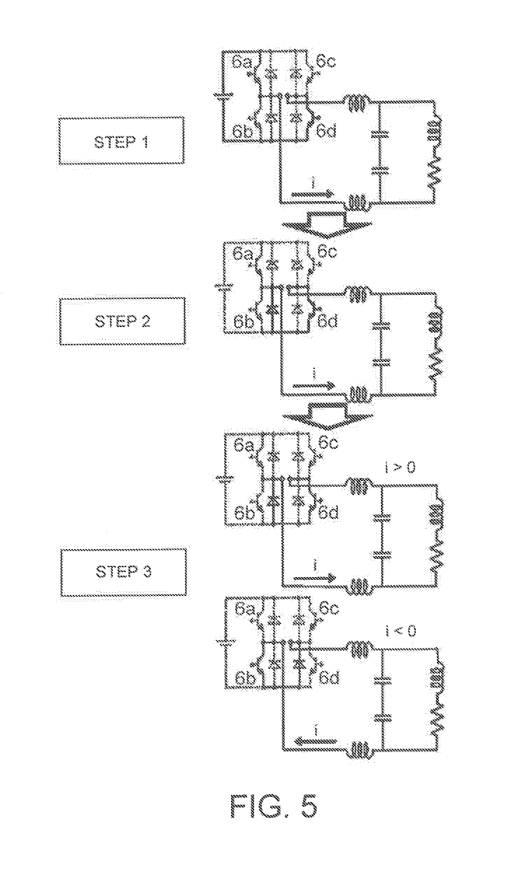

FIG. 5 shows transitions of the bridge circuit in the case in which the first switching element 6a to the fourth switching element 6d are operated based on the gate signals shown in FIG. 4. In each step, the wiring of the circuits to which a current flows is shown by solid lines, and the wiring of the circuit to which a current does not flow is shown by broken lines.

In step 1, since the first switching element 6a and the fourth switching element 6d are turned on at the same time, the current flows in the positive direction. Then, if the current does not rapidly becomes 0 because of the load 8 during step 2 when the first switching element 6a is turned off, regardless of the state of ON/OFF of the second switching element 6b, a current, flows through the free wheeling diode which is installed in parallel to the second switching element 6b, and the fourth switching element 6d. In step 3, when the second switching element 6b is turned on, the current in the positive direction is reduced, and, if the direction of the current is changed, the current f lows through the free wheeling diode, which is installed in parallel to the fourth switching element 6d, and the second switching element 6b. At this point, since the current in the reverse direction of the positive direction flows, the current does not flow to the fourth switching element 6d. By virtue of this, without connecting to the electric power source 6e, the impulse response to the load 8 can be measured. At this point, an impulse voltage signal (also referred to as a second signal) is output from the bridge circuit. Note that the duration of the Dead time of step 2 is arbitrarily set within the range in which the direction of the current; is not changed after impulse input. The current in the positive direction is the current which flows counterclockwise (CCW) in the circuit of the LPF 7 and the load 8. The reverse direction is the direction which flows clockwise (CW) in the circuit of the LPF 7 and the load 8 and shows the current (current in negative direction) in the reverse direction of the positive direction. The gate signals of the generator 4b are created by using a command value stored in advance in, for example, a storage device (not shown) provided outside. Examples of the storage device include a hard disk drive (HDD), an optical disk, a magnetic tape, a semiconductor memory, a read only memory (ROM), and a random access memory (RAM).

The data at a point N in a case in which a terminal voltage vₜ and a current i of the load are measured by a sampling cycle Tₛ when the above described impulse input is applied is expressed by Equations (7) and (8).

vₜₘ=[vₜ₀ vₜ₁ vₜ₂ . . . v_{tN}] (7)

iₘ=[i₀ i₁ i₂ . . . i_{N}] (8)

A FIR (Finite Impulse Response) filter model from the PWM input to the terminal voltage is expressed by Equation (9).

$$\frac{{V}_{t} ( k )}{{V}_{0} ( k )} = \frac{{v}_{t 0} {z}^{N} + {v}_{t 1} {z}^{N - 1} + {v}_{t 2} {z}^{N - 2} + … + {v}_{tN - 1} z + {v}_{tN}}{{z}^{N}} \qquad ( 9 )$$

A FIR filter model from the PWM input to the current is expressed by Equation (10).

$$\frac{I ( k )}{{V}_{0} ( k )} = \frac{{i}_{0} {z}^{N} + {i}_{1} {z}^{N - 1} + {i}_{2} {z}^{N - 2} + … + {i}_{N - 1} z + {i}_{N}}{{z}^{N}} \qquad ( 10 )$$

According to Equations (9) and (10), the transmission characteristic from the terminal voltage to the current is obtained as Equation (11).

$$\frac{I ( k )}{{V}_{t} ( k )} = \frac{{i}_{0} {z}^{N} + {i}_{1} {z}^{N - 1} + {i}_{2} {z}^{N - 2} + … + {i}_{N - 1} z + {i}_{N}}{{v}_{t 0} {z}^{N} + {v}_{t 1} {z}^{N - 1} + {v}_{t 2} {z}^{N - 2} + … + {v}_{tN - 1} z + {v}_{tN}} \qquad ( 11 )$$

According to Equation (11), a frequency characteristic can be calculated. For example, if a resistance value R is desired to be obtained, Equation (12) can be obtained by employing “z=1” in Equation (11).

$$\frac{1}{R} = \frac{{i}_{0} + {i}_{1} + {i}_{2} + … + {i}_{N - 1} + {i}_{N}}{{v}_{t 0} + {v}_{t 1} + {v}_{t 2} + … + {v}_{tN - 1} + {v}_{tN}} \qquad ( 12 )$$

It is not limited to modeling by the FIR form by using the time series data of the impulse response, but the transmission characteristic may be subjected to fitting by a different form based on time series waveforms. For example, an assumption is made as a model of a continuous system as shown, by Equation (13) by using the load, and identification may be carried out by fitting parameters so that they match the measured impulse response. By virtue of this, the inductance and resistance value can fee obtained.

$$\frac{i ( s )}{vt ( s )} = \frac{1}{Ls + R} \qquad ( 13 )$$

By identifying the actual current from the load, characteristic identified in the second mode and carrying out feed-back to the controller 3 through the feedback loop 9, the current error between the current command value from the command part 2 and the actual current can be derived with high precision.

In the control apparatus 1, since the first mode and the second mode can be switched by the switching part 5, a process of switching the measurement of the first mode which is a normal operation of the circuit to the second mode in which the load characteristic is identified at a predetermined interval, and a process of carrying out the measurement of the first mode again after the measurement, of the second mode is completed, may be added. Examples of the predetermined interval also include a case in which the mode is repeatedly switched to the second mode at every constant period by, for example, a program. Also, a case in which the timing of switching from the first mode to the second mode is directly input from, for example, an input device (not shown) by a utilizer (user) is included.

Meanwhile, in a case in which the mode is to be switched to the first mode after the load characteristic is identified in the second mode, for example, the mode may be switched to the first mode after convergence of the impulse response is detected by a detector (not shown), which detects convergence of the impulse response.

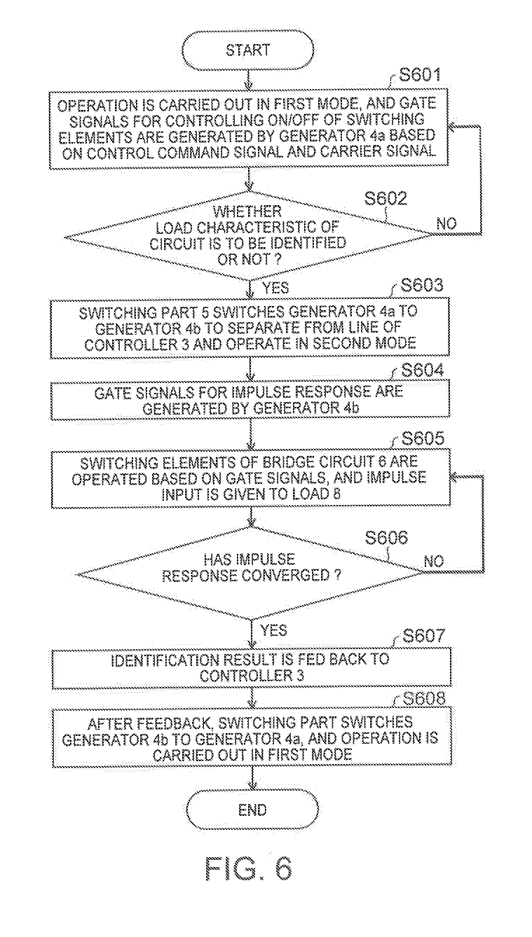

FIG. 6 shows an example of an operation flow of the control apparatus 1 according to the first embodiment.

The controller 1 of the present embodiment operates in the first mode first, and generates the gate signals for controlling On/Off of the switching elements based on the control command signal and the carrier signal by the generator 4a (S601). Then, whether the load characteristic of the circuit is to be identified or not is judged (S602). In case of “Yes” (the load characteristic of the circuit is to be identified), the switching part 5 switches the generator 4a to the generator 4b to carry out separation from the line of the controller 3 and carry out operation in the second mode (S603). In case of “N”, the operation in the first mode is continuously carried out (S601). The gate signals for impulse response are generated by the generator 4b (S604). The switching elements of the bridge circuit 6 are operated based on the gate signals, and the impulse input is applied to the load 8 (S605). Whether the impulse response has converged or not is detected (S606). In case of “Yes”, the result of identification is fed back to the controller 3 (S607). In case of “No”, the impulse input is applied again (S605). After the feedback is carried out, the switching part 5 switches the generator 4b to the generator 4a, and operation is carried out in the first mode (S608). Then, normal operation is carried out in the first mode.

Next, Comparative Example 10 of a method of identifying the load characteristic by the second mode of the present embodiment will be described.

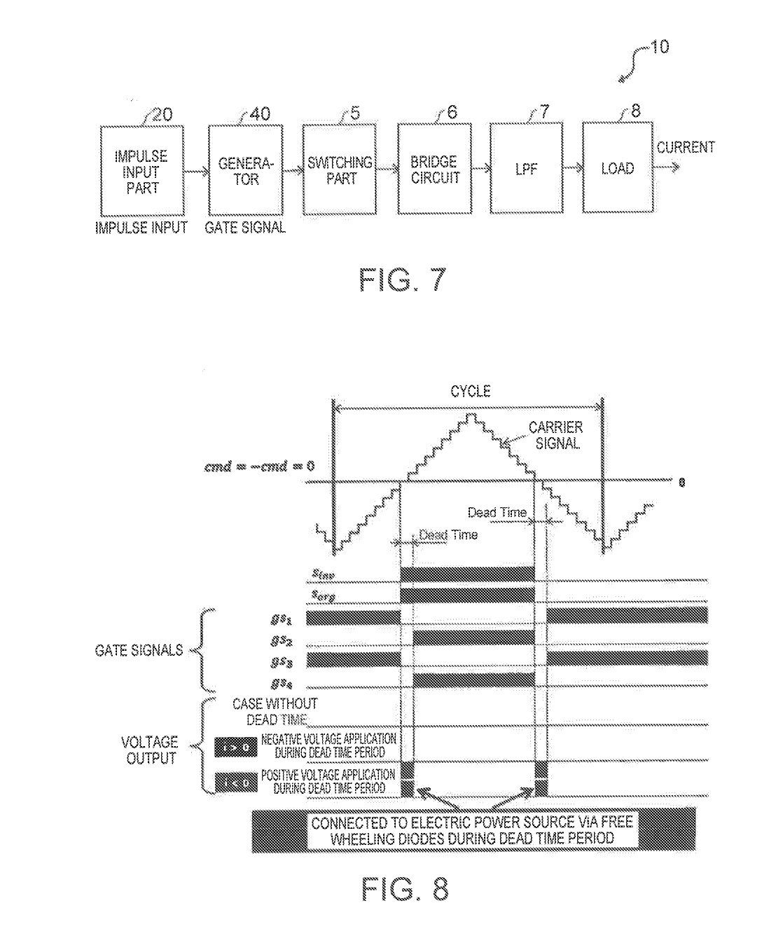

FIG. 7 shows a block diagram of a case in which a load characteristic of Comparative Example 10 is to be identified. As shown in FIG. 7, an impulse input part 20, which applies an impulse input to a generator 40, which generates gate signals for controlling On/Off of switching elements, is provided. The configurations of a bridge circuit connected to the generator 40, a LPF connected to the bridge circuit, and a load connected to the LPF are similar to those of the control apparatus according to the first embodiment.

In Comparative Example 10, the impulse input is applied to the generator 40, and the load has, for example, a coil (L). Therefore, even after a control command signal becomes “0” (zero) because of the impulse input, a current continues flowing to the bridge circuit.

FIG. 8 shows gate signals (gs₁ to gs₄) generated by the generator 40 in a case in which the control command signal (cmd) is 0. As shown in FIG. 8, the gate signals are generated by comparing a carrier signal (cs) and the control command signal (cmd). The generation of the gate signals is carried out by using above described Equations (1) to (6). If the control command signal (cmd) is 0, S_{org} and Sᵢₙᵥ become the same values, and all the switching elements of the bridge circuit becomes an Off state during Dead time.

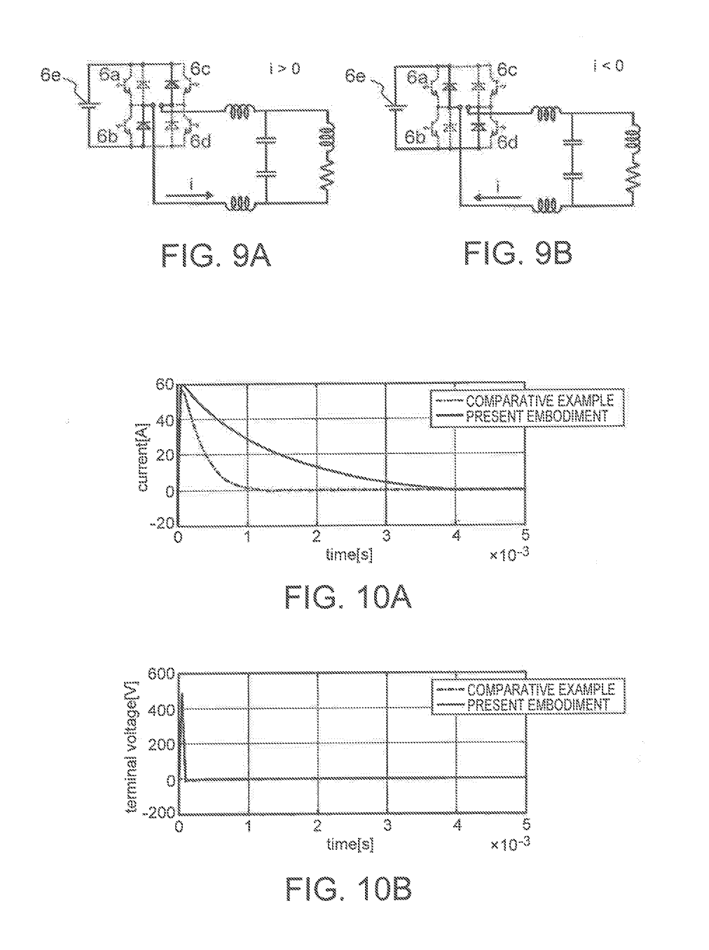

FIGS. 9A and 9B show the state of the bridge circuit during the Dead time. In the wiring of the circuit, the wiring through which a current flows is shown by solid lines, and the wiring through which a current does not flow is shown by broken lines. As shown in FIGS. 9 and 9B, when all the switching elements are Off, the load is connected to the electric power source via free wheeling diodes, and, therefore, the output of PWM does not become an impulse. Therefore, in Comparative Example 10, the load characteristic cannot be precisely identified. The influence thereof is expressed by Equation (14), wherein “E” represents an electric power source voltage, “T_{d}” represents Dead time, and “F_{c}” represents a carrier frequency.

ΔV=ET_{d}F_{c} (14)

In Comparative Example, since the impulse input is applied to the generator as the control command signal (cmd), a precise load characteristic cannot be identified since the load is connected to the electric power source 6e during Dead time while the control command signal (cmd) is “0” (zero). However, in the second mode of the present embodiment, unintended connection between the electric power source 6e and the load is shut off by directly operating the switching elements, and the impulse input, can foe applied to the load 8.

Next, simulation results of a case in which the second mode of the control apparatus 1 according to the present embodiment is applied to a target model will be described.

FIGS. 10A and 10B shows the impulse responses of the currents and the terminal voltage in the case in which the second mode of the control apparatus 1 according to the present embodiment is applied and the case of Comparative Example. Solid lines in FIGS. 10A and 10B represent the current and the terminal voltage of the case in which the second mode according to the present embodiment is applied, and broken lines represent the current and the terminal voltage of the case of Comparative Example.

The impulse responses of currents show different results in the present embodiment and Comparative Example.

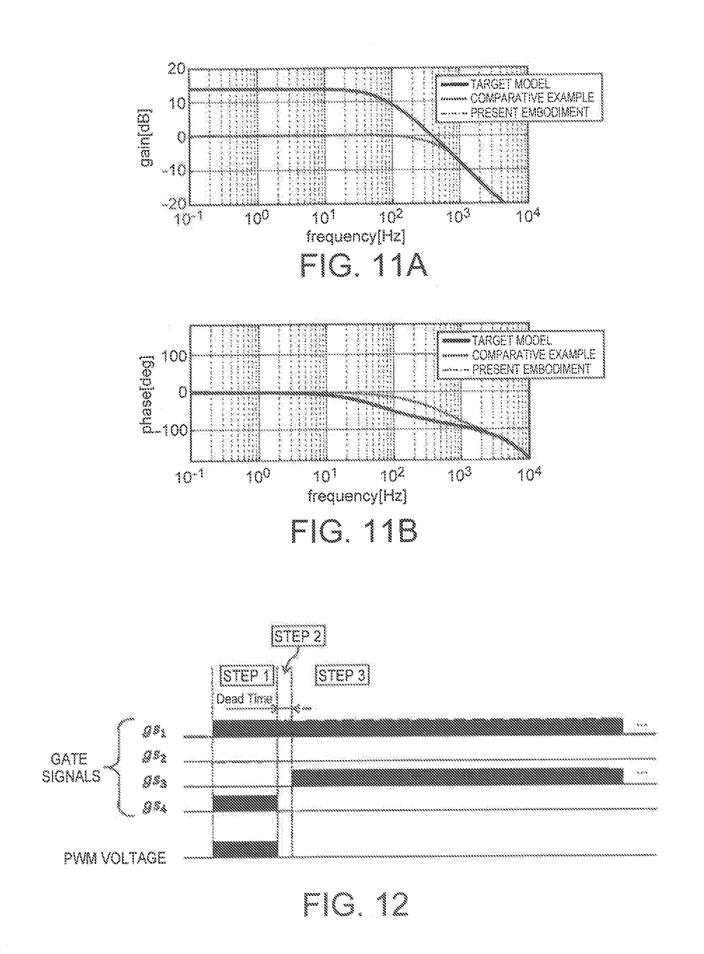

FIGS. 11A and 11B show frequency characteristics of the loads of the present embodiment and Comparative Example with respect to a target model. Solid lines represent the frequency characteristics of the target model, dashed-dotted lines represent the frequency characteristics of the load of the case in which the second mode of the present embodiment is applied, and broken lines represent the frequency characteristics of the load of the case in which Comparative Example is applied.

It can be understood that the case in which the load characteristic is identified by the second mode of the present embodiment matches better with the target model.

By using the second mode of the control apparatus 1 according to the present embodiment, the load characteristic of the circuit can be identified with high precision in a short period of time.

Moreover, the load characteristic of the circuit can be timely identified by switching the first mode and the second, mode by the switching part.

### Second Embodiment

A control apparatus according to a second embodiment will be described with reference to FIG. 12.

FIG. 12 shows gate signals created by the generator 4b in the second mode of the control apparatus 1. In the control apparatus according to the second embodiment, the gate signals which are generated by the generator 4b and are for applying an impulse input to the load are different from those of the control apparatus of the first embodiment. The configurations other than that are similar to those of the control apparatus according to the first embodiment.

As shown in FIG. 12, the first switching element 6a and the fourth switching element 6d are turned on at the same time and are connected to the electric power source 6e (step 1). In this process, the second and third switching elements 6b and 6c are Off. Then, the fourth switching element 6d is turned off while the first switching element 6a is continued to be On, and Dead time for preventing short-circuit of the electric power source 6e is allowed to elapse (step 2). Then, the third switching element 6c is turned on (step 3). Then, the switching elements are not subjected to operation until the current converges to “0” (zero).

The transitions of the bridge circuit 6 in this process will be described. In the state of step 1, a current flows in the positive direction. In step 2, since the fourth switching element 6d is turned off, the electric power source 6e is disconnected. The current passes through the first switching element 6a, further passes through the free wheeling diode connected in parallel to the third switching element 6c, and flows in the positive direction. In step 3, when the third switching element 6c is turned on, the current in the positive direction is reduced, and, if the direction of the current is changed, the current flows through the free wheeling diode, which is installed in parallel to the first switching element 6a, and the third switching element 6c. At this point, since the current in the reverse direction of the positive direction flows, the current does not flow to the first switching element 6a. By virtue of this, without connecting to the electric power source 6e, the impulse response can foe measured.

In the present embodiment, the impulse input in the positive direction, which is the same as that of the control apparatus according to the first, embodiment, is applied.

### Third Embodiment

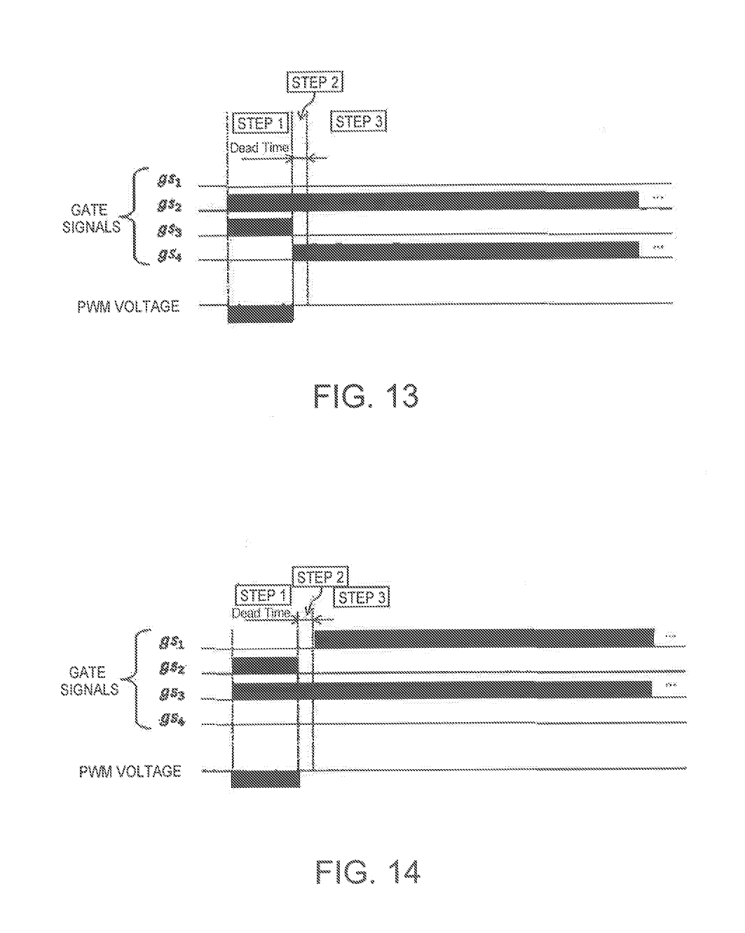

A control apparatus according to a third embodiment will be described with reference to FIG. 13.

FIG. 13 shows gate signals created by the generator 4b in the second mode of the control apparatus 1. In the control apparatus according to the third embodiment, the gate signals which are generated by the generator 4b and are for applying an impulse input to the load are different from those of the control apparatus of the first embodiment. The configurations other than that, are similar to those of the control apparatus according to the first embodiment.

As shown in FIG. 13, the second switching element 6b and the third switching element 6c are turned on at the same time and are connected to the electric power source 6e (step 1). In this process, the first and fourth switching elements 6a and 6d are Off. Then, the third switching element 6c is turned off while the second switching element 6b is continued to be On, and Dead time for preventing short-circuit of the electric power source 6e is allowed to elapse (step 2). Than, the fourth switching element 6d is turned on (step 3). Then, the switching elements are not subjected to operation until the current converges to “0” (zero).

The transitions of the bridge circuit 6 in this process will be described. In the state of step 1, a current flows in the negative direction. In step 2, since the third switching element 6c is turned off, the electric power source 6e is disconnected. The current passes through the second, switching element 6b, further passes through the free wheeling diode connected in parallel to the fourth switching element 6d, and flows in the negative direction. In step 3, when the fourth switching element 6d is turned on, the current in the negative direction is reduced, and, if the direction of the current is changed, the current flows through the free wheeling diode, which is installed in parallel to the second switching element 6b, and the fourth switching element 6d. At this point, since the current in the reverse direction of the negative direction flows, the current does not flow to the second switching element 6b. By virtue of this, without connecting to the electric power source 6e, the impulse response can be measured.

In the present embodiment, the impulse input in the negative direction, which is the opposite of that of the control apparatus according to the first embodiment, is applied.

### Fourth Embodiment

A control apparatus according to a fourth embodiment will be described with reference to FIG. 14.

FIG. 14 shows gate signals created by the generator 4b in the second mode of the control apparatus 1. In the control apparatus according to the fourth embodiment, the gate signals which are generated by the generator 4b and are for applying an impulse input to the load are different from those of the control apparatus of the first embodiment. The configurations other than that are similar to those of the control apparatus according to the first embodiment.

As shown in FIG. 14, the second switching element 6b and the third switching element 6c are turned on at the same time and are connected to the electric power source 6e (step 1). In this process, the first and fourth switching elements 6a and 6d are Off. Then, the second switching element 6b is turned off while the third switching element 6c is continued to be On, and Dead time for preventing short-circuit of the electric power source 6e is allowed to elapse (step 2). Then, the first switching element 6a is turned on (step 3). Then, the switching elements are not subjected to operation until the current converges to “0” (zero).

The transitions of the bridge circuit 6 in this process will be described. In the state of step 1, a current flows in the negative direction. In step 2, since the second switching element 6b is turned off, the electric power source 6e is disconnected. The current passes through the third switching element 6c, further passes through the free wheeling diode connected in parallel, to the first, switching element 8a, and flows in the negative direction. In step 3, when the first switching element 6a is turned on, the current in the negative direction is reduced, and, if the direction of the current is changed, the current flows through the free wheeling diode, which is installed in parallel to the third switching element, 6c, and the first switching element 6a. At this point, since the current in the reverse direction of the negative direction flows, the current does not flow to the third switching element 6c. By virtue of this, without connecting to the electric power source 6e, the impulse response can be measured.

In the present embodiment, the impulse input in the negative direction, which is the opposite of that of the control apparatus according to the first embodiment, is applied.

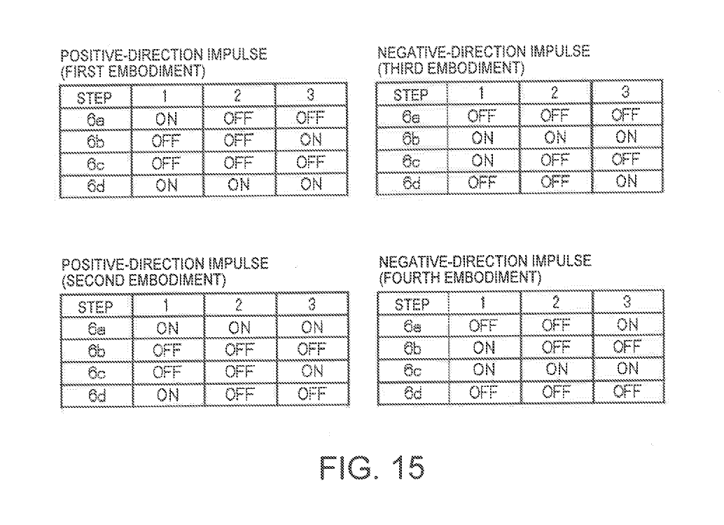

FIG. 15 shows operation patterns of the switching elements 6a to 6d according to the gate signals of the generator 4b according to the first to fourth embodiments.

As shown in FIG. 15, the impulse input in the positive direction or the negative direction can be applied to the load 8 by directly operating the switching elements of the bridge circuit 6 by the generator 4b.

The control apparatuses according to the first to fourth embodiments can be used as current controlling devices of rotating electric machines, etc. Also, the control apparatuses are not limited to the rotating electric machines, but can be used as control devices of light emitting diodes (LED), magnetic resonance imaging (MRI: nuclear magnetic resonance imaging method) devices, etc. Also, the control apparatuses can be used as control circuits (control devices) incorporated in various electronic circuits.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control apparatus capable of identifying a load characteristic of a circuit by an impulse response, the control apparatus comprising:
a controller that provides a control signal;
a first generator that generates first gate signals based on the control signal;
a second generator that generates second gate signals to identify the load characteristic of the circuit;
a switching part that switches connection to one of the first generator and the second generator; and
a bridge circuit connected to the switching part, and including a plurality of switching elements; wherein,
in case that the switching part is connected to the first generator, the switching elements are operated based on the first gate signals, and the bridge circuit outputs a first signal, and,
in case that the switching part is connected to the second generator, the switching elements are operated based on the second gate signals, and the bridge circuit outputs an impulse second signal different from the first signal.

2. The control apparatus according to claim 1, wherein
the bridge circuit includes first, to fourth switching elements, and diodes connected in parallel to the respective switching elements.

3. The control apparatus according to claim 1, wherein
the switching part carries out switching between a first mode of carrying out a normal operation of the circuit by connection with the first generator and a second mode of identifying the load characteristic of the circuit by connection with the second generator.

4. The control apparatus according to claim 3, wherein,
when the load characteristic of the circuit is to be identified, the switching part switches the first mode to the second mode.

5. The control apparatus according to claim 3, wherein,
after the load characteristic of the circuit is identified, the switching part switches the second mode to the first mode.

6. The control apparatus according to claim 2, wherein
the second generator generates, in order to identify the load characteristic of the circuit, the second gate signals including
a first, step of turning on the first and fourth switching elements and turning off the second and third switching elements,
a second step of turning off the first to third switching elements and turning on the fourth switching element, the second step continued from the first step, and
a third step of turning off the first and third switching elements and turning on the second and fourth switching elements, the third step continued, from the second step.

7. The control apparatus according to claim 2, wherein
the second generator generates, in order to identify the load characteristic of the circuit, the second gate signals including
a first step of turning on the first and fourth switching elements and turning off the second and third switching elements,
a second step of turning off the second to fourth switching elements and turning on the first switching element, the second step continued from the first step, and
a third step of turning on the first and third switching elements and turning off the second and fourth switching elements, the third step continued from the second step.

8. The control apparatus according to claim 2, wherein
the second generator generates, in order to identify the load characteristic of the circuit, the second gate signals including
a first step of turning on the second, and third switching elements and turning off the first and fourth switching elements,
a second step of turning off the first, third, and fourth switching elements and turning on the second switching element, the second step continued from the first step, and
a third step of turning off the first and third switching elements and turning on the second and fourth switching elements, the third step continued from the second step.

9. The control apparatus according to claim 2, wherein
the second generator generates, in order to identify the load characteristic of the circuit, the second gate signals including
a first step of turning on the second and third switching elements and turning off the first and fourth switching elements,
a second step of turning off the first, second, and fourth switching elements and turning on the third switching element, the second step continued from the first step, and
a third step of turning on the first and third switching elements and turning off the second and fourth switching elements, the third step continued from the second step.

10. The control apparatus according to claim 6, wherein
a duration of the second step is arbitrarily set within a range in which a direction of a current flowing to the circuit is not changed after inputting the second signal, and
after the third step, the switching elements are not operated until the current flowing to the circuit converges zero.

11. The control apparatus according to claim 7, wherein
a duration of the second step is arbitrarily set within a range in which a direction of a currant flowing to the circuit is not changed after inputting the second signal, and
after the third step, the switching elements are not operated until the current flowing to the circuit converges zero.

12. The control apparatus according to claim 8, wherein
a duration of the second step is arbitrarily set within a range in which a direction of a current flowing to the circuit is not changed after inputting the second signal, and
after the third step, the switching elements are not operated until the current flowing to the circuit converges zero.

13. The control apparatus according to claim 9, wherein
a duration of the second step is arbitrarily set within a range in which a direction of a current flowing to the circuit is not changed after inputting the second signal, and
after the third step, the switching elements are not operated until the current flowing to the circuit converges zero.

14. A control apparatus capable of identifying a load characteristic of a circuit by an impulse response, the control apparatus comprising:
a generator that generates gate signals indicating operations of a plurality of switching elements; and
a bridge circuit including the plurality of switching elements, that applies an impulse voltage signal to a load of the circuit by operating each of the switching elements based on the gate signals, when the load characteristic of the circuit is to be identified.

15. The control apparatus according to claim 14, wherein
the plurality of switching elements are first to fourth switching elements, and
the bridge circuit includes diodes connected in parallel to the respective switching elements.

16. The control apparatus according to claim 15, wherein
the gate signals include
a first step of turning on the first and fourth switching elements and turning off the second and third switching elements,
a second step of turning off the first to third switching elements and turning on the fourth switching element, the second step continued from the first step, and
a third step of turning off the first and third switching elements and turning on the second and fourth switching elements, the third step continued from the second step.

17. The control apparatus according to claim 15, wherein
the gate signals include
a first step of turning on the first and fourth switching elements and turning off the second and third switching elements,
a second step of turning off the second to fourth switching elements and turning on the first switching element, the second step continued from the first step, and
a third step of turning on the first and third switching elements and turning off the second and fourth switching elements, the third step continued from the second step.

18. The control apparatus according to claim 15, wherein
the gate signals include
a first step of turning on the second and third switching elements and turning off the first and fourth switching elements,
a second step of turning off the first, third, and fourth switching elements and turning on the second switching element, the second step continued from the first step, and
a third step of turning off the first and third, switching elements and turning on the second and fourth switching elements, the third step continued from the second step.

19. The control apparatus according to claim 15, wherein
the gate signals include
a first, step of turning on the second and third switching elements and turning off the first and fourth switching elements,
a second step of turning off the first, second, and fourth switching elements and turning on the third switching element, the second step continued from the first step, and
a third step of turning on the first and third switching elements and turning off the second and fourth switching elements, the third step continued from the second step.

20. A control method of a control apparatus capable of identifying a load characteristic of a circuit, by an impulse response, the control method comprising:
generating first gate signals by a first generator, based on a control, signal;
generating second gate signals to identify the load characteristic of the circuit by a second generator;
switching connection to one of the first generator and the second generator by a switching part;
when the switching part and the first generator are connected, outputting a first signal by operating each of a plurality of switching elements by a bridge circuit, based on the first gate signals; and,
when the switching part and the second generator are connected, outputting an impulse second signal different from the first signal by operating each of the plurality of switching elements by the bridge circuit, based on the second gate signals.
